(19) United States
(12) Patent Application Publication
(10) Pub. No.: US 2026/0358773 A1
(43) Pub. Date: Nov. 12, 2026

(54) PHOTOVOLTAIC MODULE STOWING DURING SNOW AND WIND EVENTS

(71) Applicant: MICHIGAN TECHNOLOGICAL UNIVERSITY, Houghton, MI (US)

(72) Inventors: Ana Dyreson, Houghton, MI (US); Ayush Chutani, Houghton, MI (US); Paul Dice, Houghton, MI (US)

(21) Appl. No.: 19/667,352

(22) Filed: May 4, 2026

Related U.S. Application Data
(60) Provisional application No. 63/801,396, filed on May 7, 2025.

(51) Int. Cl. G05B 15/02

(52) U.S. Cl. CPC G05B 15/02

(57) ABSTRACT

Exemplary embodiments of the present disclosure address problems experienced in photovoltaic (PV) power systems due to snow events, including problems associated with reduction in energy production due to snow layers on PV modules blocking solar irradiance. Embodiments disclosed herein address this problem by altering an angular orientation of PV modules so that the PV modules are facing away from wind during snow events and thereby have less snow accumulated on them than when the PV modules are not facing away from wind during snow events.

### CROSS-REFERENCE TO RELATED APPLICATIONS

This patent application claims priority to and the benefit of U.S. Provisional Patent Application Ser. No. 63/801,396, filed May 7, 2025, which is incorporated herein by reference in its entirety.

### STATEMENT OF GOVERNMENT INTEREST

This invention was made with government support under grant number 2324302 awarded by the U.S. Department of Energy/Sandia Laboratory. The government has certain rights in the invention.

### TECHNICAL FIELD

The present disclosure generally relates to stowing of photovoltaic modules before or during snow and wind events.

### BACKGROUND

Solar irradiance collected by photovoltaic (PV) modules is converted into energy via the photovoltaic effect, which is the conversion of light into electrical power. PV modules may be monofacial modules that collect light through the front face only, or bifacial PV modules that collect light through both the front and back faces. In this disclosure, the direction that the PV modules face will refer to the direction that the front faces of the PV modules are facing.

A PV power system typically comprises series and parallel circuits of PV modules, racking structures onto which the PV modules are installed, wiring, a solar inverter that converts the DC electricity produced by PV modules into AC electricity, and transformers and switchgear if the PV power system is tied to the electric grid.

The racking structure may be a fixed structure that holds the PV modules at a constant tilt angle throughout the year. This type of racking structure is called a “fixed rack”. Fixed racks generally have a southward tilt in the northern hemisphere and a northward tilt in the southern hemisphere.

The racking structure may also be a structure that has an actuator and mechanisms built in to allow adjustment of the tilt angle of the PV modules throughout the day and throughout the year. The tilt angle is typically controlled so that the PV modules track the sun, and this type of racking structure is called a “solar tracker”. A solar tracker generally puts PV modules to an eastward tilt in the morning and a westward tilt in the afternoon.

The solar tracker may have a control system, with at least one microcontroller-or microprocessor-based device, that controls the actuator.

The solar tracker control system may be under the supervision of another control system (“supervisory control system”). The supervisory control system may have at least one microcontroller-or microprocessor-based device, separate from the one in the solar tracker control system. The supervisory control system may be multiple layers of control system. For example, the supervisory control system that directly supervises the solar tracker control system may have another control system supervising it, and this higher-level supervisory control system may have indirect supervision of the solar tracker control system. In this disclosure, “supervisory control system” shall refer to both the supervisory control system that directly supervises the solar tracker control system and higher-level control systems that indirectly supervises the solar tracker control system.

When no PV module is shaded, the maximum possible power output of a PV system is generally proportional to the solar irradiance incident on the PV modules (“incident irradiance”). The actual power output may be lower, in case of component failures, grid outages, and grid curtailment.

When some PV modules are shaded, the maximum possible power output of a PV system may reduce disproportionately. The maximum possible power output with some modules shaded may be significantly lower than the maximum power output with no modules shaded multiplied by the fraction of modules shaded.

The disproportionate power reduction is typically due to how the electrical circuit is configured in a PV power system. In a PV power system, PV modules are typically first grouped into a series connection of PV modules, also known as a “PV string”. The PV modules in a PV string all share the same output current, due to the nature of the series electrical circuit. PV strings are then typically connected in parallel before feeding into an input of a solar inverter. The PV strings that are connected in parallel all share the same output voltage, due to the nature of the parallel electrical circuit. PV modules typically include bypass diodes that can provide alternate current paths, depending on the electrical operating conditions. When the operating conditions are such that no bypass diodes become active, the PV strings with shaded PV modules will have maximum possible output power limited by the output current of the most shaded PV module; The PV string output power will be disproportionately impacted by the most shaded PV module. When the operating conditions are such that some bypass diodes become active, the PV strings with shaded PV modules will have maximum possible output power reduced proportionately to the ratio of shaded PV modules, but the parallel circuit of the PV strings will experience additional reduction in the maximum possible output power due to the PV strings with shaded PV modules forcing the other PV strings with no PV modules shaded to operate at lower-than-optimum voltage. The disproportionate reduction in the maximum possible output power due to mismatch in the current-voltage characteristics between the PV modules or the PV strings is called the “mismatch loss”, and shading is a known cause for the mismatch loss.

Different factors can cause shading of PV modules in a PV power system. Some common causes are nearby buildings and power poles. It is also possible for the PV modules to shade the PV modules behind them when the sun is low, depending on the racking structure layout and design.

Shading of PV modules in a PV power system can also happen due to a snow event. Snow can accumulate on the faces of PV modules during a snow event, leading to complete or near-complete shading of all or majority of PV modules, at least temporarily. After the snow event, the amount of snow cover on the PV modules may change locally due to shedding, melting and blowing over time, leading to different levels of snow-caused shading on different PV modules of the PV system.

Because shading can cause disproportionately large power output losses, the PV system after a snow event may not recover to nominal production until snow disappears from most of the PV modules. If the snow event is followed by cold temperature, it is not uncommon for some PV modules to have full or partial snow layer on them for days and even weeks.

When the racking structure is a fixed rack, the PV power system in a heavy snow region may be designed with a steeper tilt angle than a similar system in a region at a similar latitude but with less snow. The steeper tilt angle maybe reduce the amount of initial snow accumulation and it may also promote snow shedding, leading to an overall smaller energy production loss due to snow. However, the steeper-than-nominal tilt angle may reduce the energy production in seasons without snow, due to an overall increase in the angle of incidence to the sun.

When the racking structure is a solar tracker, the solar tracker may be controlled to tilt the PV modules to a steeper-than-nominal angle during snow events. This strategy is called “snow stow”, and the snow stow may be triggered manually, or through an automatic response system that receives snow-related information through data communication. Compared to a fixed rack-based PV system, a solar tracker-based PV system may allow smaller energy production losses, because the typical maximum tilt angle of a solar tracker is steeper than the typical maximum tilt angle of a fixed rack.

### SUMMARY

Exemplary embodiments of the present disclosure address the problem of a PV power system using a solar tracker or solar trackers as racking solution experiencing energy production losses after a snow event due to snow accumulation on PV modules.

Embodiments disclosed herein address this problem by using available snow and wind information associated with a snow event, to have the PV modules tilted away from the wind during the snow event. Changing the tilt angle of the PV modules is achieved by the solar tracker control system controlling the solar tracker's actuator.

In some embodiments, the snow and wind information associated with a snow event may be in the form of a weather forecast. If such information is used, the solar tracker control system or its supervisory control system may receive or obtain the weather forecast through data communication over the internet and stow PV modules away from wind before or during a snow event, with the objective of reducing the impact of snowfall on the PV power system's energy production after the snow event.

In some embodiments, the snow and wind information associated with a snow event may be in the form of measurements made with snow and wind sensors at or near the location of the PV power system. If such information is used, the solar tracker control system or its supervisory control system may receive or obtain the measurements through data communication over the local area network or the internet and stow PV modules away from wind during a snow event, with the objective of reducing the impact of snowfall on the PV power system's energy production after the snow event.

In some embodiments, the snow and wind information associated with a snow event may be partly in the form of a weather forecast and partly in the form of measurement or measurements made with snow and wind sensors at or near the location of the PV power system. If such information is used, the solar tracker control system or its supervisory control system may receive or obtain the measurements through data communication over the local area network or the internet and stow PV modules away from wind before, before or during a snow event, with the objective of reducing the impact of snowfall on the PV power system's energy production after the snow event.

In some embodiments, the solar tracker control system or its supervisory control system may not automatically stow the PV modules away from wind for the snow stow but instead require a person or a group of persons to review and approve the snow stow prior to initiating the stow. The person or the group of persons may review and approve the snow stow before or during a snow event, with the intention of reducing the impact of snowfall on the PV power system's energy production after the snow event.

In some embodiments, the solar tracker control system or its supervisory control system may not receive or obtain the snow and wind information directly through data communication. A person or a group of persons may receive or obtain the solar and wind information by telecommunication, data communication over the internet, or data communication within a local area network. The person or a group of persons may then initiate the snow stow before or during a snow event with the user interface or user interfaces provided by a solar tracker control system or its supervisory control system with the intention of reducing the impact of snowfall on the PV power system's energy production after the snow event.

### BRIEF DESCRIPTION OF THE DRAWINGS

Example embodiments will be described and explained with additional specificity and detail through the accompanying drawings in which:

FIG. 1 illustrates an exemplary system for stowing one or more PV modules in response to a snow and wind event;

FIG. 2A illustrates a side view of a tracking system that is not in a stow configuration;

FIG. 2B illustrates a side view of a tracking system that is in a stow configuration;

FIG. 3 illustrates an exemplary sensor;

FIG. 4 illustrates a flow diagram of an example method for stowing one or more PV modules in response to a snow and wind event;

FIG. 5 illustrates a flow diagram of another example method for stowing one or more PV modules in response to a snow and wind event;

FIG. 6 illustrates a flow diagram of another example method for stowing one or more PV modules in response to a snow and wind event;

FIG. 7 illustrates a flow diagram of another example method for stowing one or more PV modules in response to a snow and wind event;

FIG. 8 illustrates a flow diagram of another example method for stowing one or more PV modules in response to a snow and wind event;

FIG. 9 illustrates a flow diagram of another example method for stowing one or more PV modules in response to a snow and wind event; and

FIG. 10 illustrates an example computer system that may be employed in stowing one or more PV modules in response to a snow event.

### DETAILED DESCRIPTION

PV power systems may have their output power reduced significantly when some or many of its PV modules are shaded and receive lower solar irradiance than the unshaded modules. The reduction in output power may be disproportionately larger than the share of PV modules shaded, due to the typical design of series and parallel electrical circuit of PV modules used in PV power systems, as explained in the Background section.

Shading of PV modules in a PV power system may happen due to a snow event. Snow can accumulate on the faces of PV modules during a snow event, leading to complete or near-complete shading of all or majority of PV modules, at least temporarily. After the snow event, the amount of snow cover on the PV modules may change locally due to shedding, melting and blowing over time, leading to different levels of snow-caused shading on different PV modules of the PV system. The PV system may not recover to nominal production until snow disappears from most of the PV modules.

When the snow event accompanies a prevailing wind direction, PV modules that are facing away from the wind may experience less snow accumulation. If many PV modules in a PV power system are facing away from the wind during a snow event with a prevailing wind direction, the PV power system may recover to nominal production faster than a PV system at a nearby location that experienced similar snow event but did not have the PV modules facing away from the wind.

In one embodiment, a method for stowing PV modules in a solar tracking installation may include receiving weather information. The weather information may include a wind speed and a wind direction before or during a snow event. The method may also include stowing the PV modules so that the PV modules are facing away from the wind direction before or during the snow event.

In some embodiments, the wind speed and the wind direction may be obtained from a weather forecast for a location where the PV modules are installed. In other embodiments, the wind speed and wind direction may be obtained from a sensor installed in a location where the PV modules are installed. Alternatively still, the wind speed and the wind direction may be obtained from both a weather forecast for a location where the PV modules are installed and from a sensor installed in the location where the PV modules are installed.

In some embodiments, the weather information may include a forecasted time of the snow event. In these embodiments, the stowing of PV modules may happen prior to the forecasted time of the snow event.

In some embodiments, the stowing of PV modules may be achieved by controlling a tilt angle of a solar tracker with an actuator that is part of a solar tracker.

In another embodiment, a method for stowing PV modules may include receiving, from a weather forecasting service, a weather forecast for a solar tracking installation location that includes a plurality of PV modules. The weather forecast may identify a snow event to occur at the solar tracking installation location. The method may also include receiving weather information from a sensor installed at the solar tracking installation location. The weather information may include a wind speed and a wind direction at the solar tracking installation location. The method may further include positioning the plurality of PV modules in a stow position in which the PV modules face away from the wind direction prior to an expected arrival of the snow event at the solar tracking installation location.

In some embodiments, the weather forecast may include a level of severity of the snow event. In these embodiments, the method may further include determining that the level of severity of the snow event exceeds a threshold level of severity.

In other embodiments, one or more non-transitory computer-readable media may comprise one or more computer-readable instructions that, when executed by one or more processors of a computing device, cause the computing device to perform a method for stowing PV modules.

In other embodiments, a computing device comprising one or more processors and one or more non-transitory computer-readable media comprising one or more computer-readable instructions that, when executed by the one or more processors, may cause the computing device to perform a method for stowing PV modules.

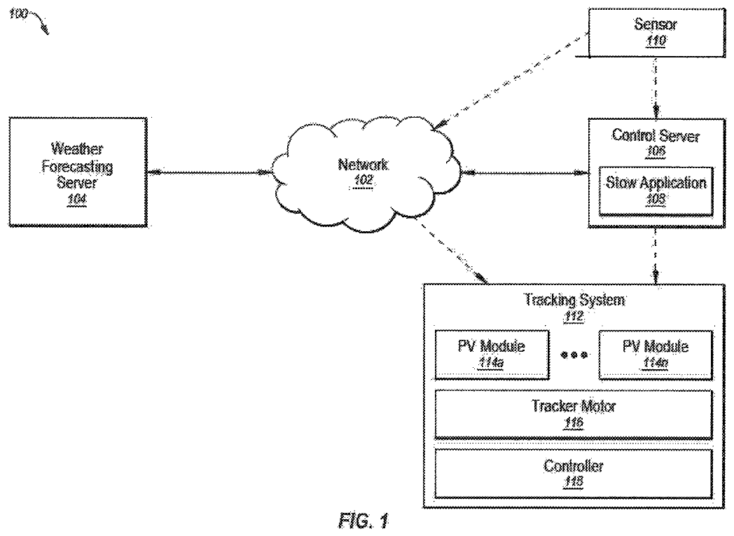

Turning to the figures, FIG. 1 illustrates an exemplary system 100 for stowing one or more PV modules in response to a weather event. The system 100 includes a network 102, a weather forecasting server 104, a control server 106, a sensor 110, and a tracking system 112.

The network 102 may be configured to communicatively couple the weather forecasting server 104, the control server 106, the sensor 110, and the tracking system 112. In some embodiments, the network 102 may be any wired or wireless network, or combination of multiple networks, configured to send and receive communications between systems and devices. The network 102 may include a Personal Area Network (PAN), a Local Area Network (LAN), a Metropolitan Area Network (MAN), a Wide Area Network (WAN), a Storage Area Network (SAN), a cellular network, the Internet, or some combination thereof.

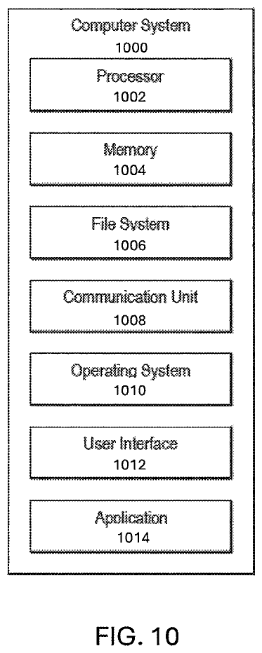

In some embodiments, the weather forecasting server 104 may be any computer system capable of providing location specific weather event forecasts over the network 102, examples of which are disclosed herein in connection with the computer system 1000 of FIG. 10. Weather event forecasts that the weather forecasting server 104 provide may identify a type of weather event forecast. For example, the weather forecasting server 104 may identify snow, wind direction, and wind speed, among other weather conditions. In addition, the weather forecasting server 104 may identify a forecasted start time of the weather event for specific locations, as well as a forecasted duration or end time of the weather event for the specific locations.

In some embodiments, the sensor 110 may be configured to identify an active weather event. For example, in one embodiment, the sensor 110 may be configured to detect a presence of snow and/or wind. The sensor 110 may be configured to determine an accumulation, or a depth, of snow, a speed of wind, and/or a direction of wind. With regard to a snow, the sensor 110 may determine the state of snowing and/or the rate of snowfall. The sensor 110 may be of various types: a pattern of electrodes that will electrically short when a water or ice or snow layer forms over them, non-contact sensors that measure the distance to a fixed surface with the expectation that the distance will change as snow accumulates, or a camera-based device. The non-contact sensors that measure the distance to a fixed surface may use different technologies such as measuring the time of flight for reflected ultrasonic pulses, measuring the time of flight for reflected laser pulses, measuring the phase difference between outgoing and reflected laser signals, and light detection and ranging (“Lidar”). With regard to wind, the sensor 110 may include instruments to measure wind speed and wind direction. These sensors are typically referred to as “anemometers”.

The sensor 110 may be positioned in sufficiently close proximity to the tracking system 112 that the sensor 110 and the tracking system 112 are experiencing the same weather event. For example, the sensor 110 may be positioned within 100 yards of the tracking system 112 so that weather data collected by the sensor 110 is representative of weather conditions at the tracking system 112 as well.

In some embodiments, the sensor 110 may be configured to communicate sensed data to the control server 106 through the network 102. In other embodiments, the sensor 110 may not be connected to the network 102. In these embodiments, the sensor 110 may be communicatively coupled to the control server 106 through a local wired or wireless communication link. For example, in one embodiment, the sensor 110 may be communicatively coupled to the control server 106 via a wireless connection, such as a Bluetooth connection.

In some embodiments, the tracking system 112 includes a plurality of PV modules 114a-114n, a tracker motor 116, and a controller 118. The PV modules 114a-114n may include solar panels that are configured to convert sunlight into power. An angular orientation of the PV modules 114a-114n may be adjustable in order to enable the PV modules to track a location of the Sun throughout the day. The tracker motor 116 may be mechanically coupled to the PV modules 114a-114n to selectively adjust the angular orientation of the PV modules 114a-114n. In addition to tracking the location of the Sun, the tracker motor 116 may position the PV modules 114a-114n into a stow configuration. A stow configuration may be a configuration in which the PV modules are angled in a non-horizontal position. In some embodiments, the stow configuration may be the largest angular position, or close to the largest angular position, that is possible for the tracker motor 116 and PV modules 114a-114n. For example, the angular configuration for PV modules in a stow configuration may be between 50 and 55 degrees from horizontal.

The controller 118 may control the tracker motor 116 and the angular position of the PV modules 114a-114n. For example, the controller may include a microcontroller-or microprocessor-based device that calculates the solar position and controls actuators and mechanisms to put PV modules at different tilt angles based on the time of the day and the time of the year. Alternatively, the tracking system 112 may include a sensor that can detect the position of the Sun in real time (“solar position sensor”). A microcontroller-or microprocessor-based device or an analog-circuit-based feedback device may control the actuator based on the solar position sensor signal to put PV modules at different tilt angles based on the time of the day and the time of the year.

The controller 118 may also provide instructions to the tracker motor 116 to position the PV modules 114a-114n into a stow configuration, or to remove the PV modules 114a-114n from the stow configuration. The tracking system 112 is communicatively coupled to the control server 106 to receive these instructions from the control server 106. In some embodiments, the tracking system 112 may be configured receive these instructions through the network 102. In other embodiments, the tracking system 112 may not be connected to the network 102. In these embodiments, tracking system 112 may be communicatively coupled to the control server 106 through a local wired or wireless communication link. For example, in one embodiment, the tracking system 112 may be communicatively coupled to the control server 106 via a wireless connection, such as a Bluetooth connection.

In some embodiments, the control server 106 may be any computer system capable of receiving weather event forecasts over the network 102, examples of which are disclosed herein in connection with the computer system 1000 of FIG. 10. The control server 106 includes a stow application 108. The stow application 108 may receive weather event forecasts from the weather forecasting server 104 through an application programming interface (API) request sent by the control server 106 to the weather forecasting server 104. In other embodiments, the weather event forecasts may be received through aerial broadcast.

In one embodiment, the stow application 108 may determine if a threshold level of severity is met based on a weather event forecast received from the weather forecasting server 104 alone. In this embodiment the stow application 108 may compare a level of severity of a weather event forecast for a location of the tracking system 112 to a threshold level of severity. This threshold level of severity may be an amount snow, an average velocity of wind, top wind gust velocities, wind direction, a likelihood of power outage, etc. If the level of severity of the weather event forecast meets or exceeds threshold level of severity, the stow application 108 may communicate an instruction to the controller 118 to position the PV modules 114a-114n in the stow configuration.

In another embodiment, the stow application 108 may determine if a threshold level of severity is met based on data received from the sensor 110 alone. In this embodiment, the stow application 108 may compare an actual level of severity of a weather event at the location of the tracking system 112, as measured by the sensor 110, to a threshold level of severity. This threshold level of severity may be an amount snow, an average velocity of wind, top wind gust velocities, wind direction, lightening strikes, etc. If the actual level of severity of the weather event meets or exceeds the threshold level of severity, the stow application 108 may communicate an instruction to the controller 118 to position the PV modules 114a-114n in the stow configuration.

In yet another embodiment, determining if a threshold level of severity is met may be based on a combination of data from the weather forecasting server 104 and data from the sensor 110. For example, a threshold level of severity may require a weather event forecast to exceed a certain amount of snow and that an actual accumulation of snow, sensed by the sensor 110, at the location of the tracking system 112 be present in order to trigger an instruction to position the PV modules 114a-114n in the stow configuration.

The stow application 108 may also receive data, as provided above, from the sensor 110. The stow application 108 may be configured to evaluate data from the weather forecasting server 104 and/or the sensor 110 to determine if the PV modules 114a-114n should be positioned in the stow configuration. In another embodiment, a PV power system may have a person or a group of persons that supervises the solar tracker control system or the supervisory control system. The solar tracker control system or the supervisory control system may provide means for the person or the group of persons to command the solar tracker control system or the supervisory control system to put PV modules at specific tilt angles.

In one embodiment, the stow application 108 may determine if a threshold level of severity is met based on a weather event forecast received from the weather forecasting server 104 alone. The weather forecast method may be synoptic forecasting that depends on human experts or a trained artificial intelligence. The weather forecast method may be numerical weather prediction that uses deterministic computer models to process current weather observations to forecast future weather. In this embodiment the stow application 108 may compare a level of severity of a weather event forecast for a location of the tracking system 112 to a threshold level of severity. This threshold level of severity may be an amount of snow, an average velocity of wind, top wind gust velocities, a likelihood of power outage, etc. If the level of severity of the weather event forecast meets or exceeds threshold level of severity, the stow application 108 may communicate an instruction to the controller 118 to position the PV modules 114a-114n in the stow configuration.

In another embodiment, the stow application 108 may determine if a threshold level of severity is met based on data received from the sensor 110 alone. In this embodiment, the stow application 108 may compare an actual level of severity of a weather event at the location of the tracking system 112, as measured by the sensor 110, to a threshold level of severity. This threshold level of severity may be an actual amount of snow, an average velocity of wind, top wind gust velocities, etc. If the actual level of severity of the weather event meets or exceeds the threshold level of severity, the stow application 108 may communicate an instruction to the controller 118 to position the PV modules 114a-114n in the stow configuration.

In yet another embodiment, determining if a threshold level of severity is met may be based on a combination of data from the weather forecasting server 104 and data from the sensor 110. For example, a threshold level of severity may require a weather event forecast to exceed a certain amount of snow and that an actual accumulation of snow, sensed by the sensor 110, at the location of the tracking system 112 be present in order to trigger an instruction to position the PV modules 114a-114n in the stow configuration.

An instruction to stow may include a decision on whether to stow the PV modules 114a-114n such that the PV modules face away from the wind before or during a snow event, with the objective of reducing the amount of snow accumulation on PV modules during the snow event and thereby reducing the impact of snowfall on the PV power system's energy production after the snow event. The tracking system 112 may then control an actuator or actuators in the solar tracker control system to put PV modules at a tilt angle where the PV modules are facing away from the wind.

The stow application 108 may also evaluate data from the sensor 110 to determine when to position the PV modules 114a-114n in the stow configuration and when to remove the PV modules 114a-114n from the stow configuration. For example, the stow application 108 may wait until an actual accumulation of snow is present at the location of the tracking system 112 before an instruction is sent to position the PV modules 114a-114n in the stow configuration. In another embodiment, if the sensor 110 senses a lightning strike, the stow application 108 may immediately position the PV modules 114a-114n in the stow configuration.

Modifications, additions, or omissions may be made to the system 100 without departing from the scope of the present disclosure. For example, in some embodiments, the system 100 may include additional components similar to the components illustrated in FIG. 1 that each may be configured similarly to the components illustrated in FIG. 1. In one such embodiment, a system for stowing one or more PV modules in response to a weather event forecast may not include a sensor. In these embodiments, a decision on whether to position one or more PV modules may be based on a forecast received from a weather forecasting server alone. In another embodiment, a system for stowing one or more PV modules in response to a weather event forecast may not include a connection to a weather forecasting server. In these embodiments, a decision on whether to position one or more PV modules may be based on a sensor alone.

In some embodiments, a solar tracker control system may request approval from a person or a group of persons to approve of the solar tracker control system's decision to tilt the PV modules to have them face away from the wind before or during a snow event. The person or the group of persons may approve the decision with the intention of reducing the amount of snow accumulation on PV modules during the snow event and thereby reducing the impact of snowfall on the PV power system's energy production after the snow event.

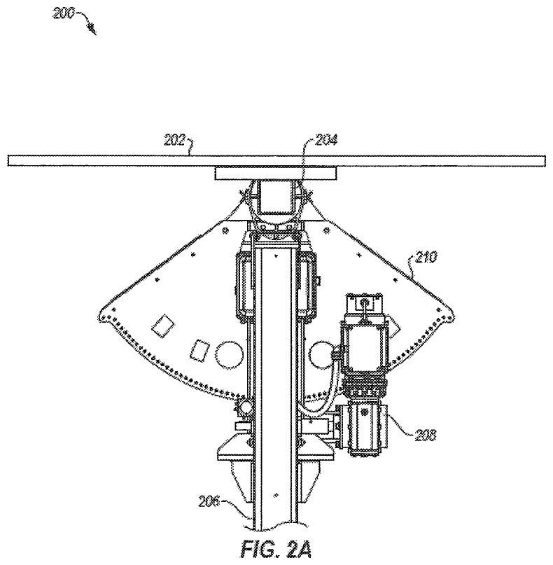

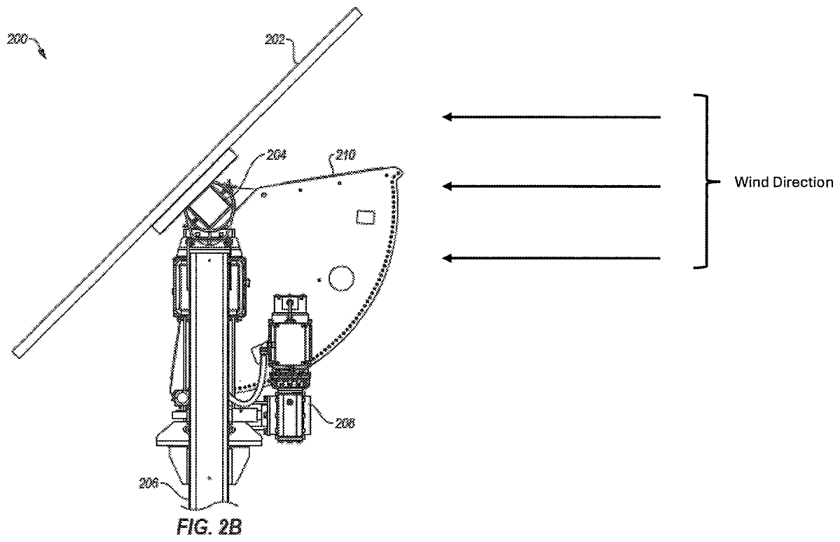

FIGS. 2A and 2B illustrate a side view of a tracking system 200. The tracking system 200 includes a PV module 202 that is coupled to a torque tube 204. The torque tube is coupled to a support structure 206 in a way that allows the torque tube 204 and the PV module 202 to rotate relative to the support structure 206. A tracker motor 208 is mechanically coupled to the torque tube through a spur gear 210. The tracker motor 208 is configured to change an angular orientation of the PV module 202 relative to the support structure 206. The tracking system 200 may also include a controller (not shown) and may be similar to the tracking system 112 of FIG. 1.

In FIG. 2A, the tracker motor 208 has positioned the PV module 202 in a generally horizontal configuration, which is ideal for generating energy when the sun is directly overhead. In FIG. 2B, the tracker motor 208 has positioned the PV module 202 into a stow configuration, in which the PV module 202 is not horizontal, but at an angle relative to horizontal. In some embodiments, the stow configuration may be the largest tilt angle or close to the largest tilt angle that motor 208 is capable of positioning the PV module 202. In some embodiments, a stow configuration may be between 50 and 55 degrees from horizontal.

As can be seen in FIG. 2B, the tracker motor 208 has positioned the PV module 202 so that it faces away from the direction in which the wind is blowing. This may prevent snow accumulation on the face of the PV module 202 that would occur if the PV module 202 were stowed facing toward the direction of the wind.

In a stow configuration, snow may not be able to accumulate on the surface of the PV module 202. Due to the angle of the PV module 202, during a snow event, snow may simply slip off the lower edge of the PV module, thus preventing damage to the PV module and other components of the tracking system 200 that may result from the weight of snow accumulation on the top of the PV module 202.

The tracking system 200 may also include a communication mechanism (not shown) through which it may receive instructions for controlling the tracker motor 208 and the PV module 202. This communication mechanism may be a wired or wireless communication link. In some embodiments, the tracking system 200 may communicate through the Internet. In other embodiments, the tracking system 200 may communicate through a local communication link, such as a wired or local wireless link, such as a Bluetooth link.

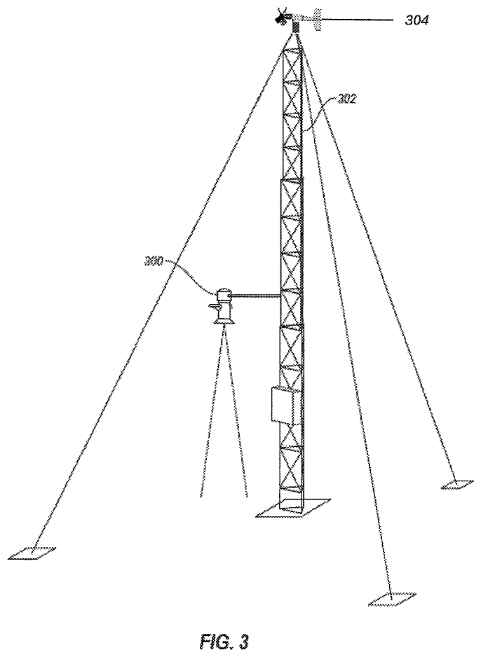

FIG. 3 illustrates an exemplary snow sensor 300 and an exemplary wind sensor 304 mounted at some distance above the ground on a structure 302. The snow sensor 300 may be configured to measure a distance from the sensor to the ground in order to determine whether snow is present. The snow sensor 300 may also determine an accumulation, or an amount of snow on the ground. In some embodiments, the snow sensor 300 may be an ultrasonic snow sensor that sends pulses of ultrasound waves toward the ground to calculate the distance to the ground by measuring the time for reflected waves to return. In other embodiments, the snow sensor 300 may be a laser-based sensor.

The wind sensor 304 may be an anemometer including but not limited to a cup anemometer, vane anemometer, hot-wire anemometer, laser Doppler anemometer, ultrasonic anemometer, plate anemometer, tube anemometer, or ping-pong ball anemometer. The wind sensor 304 may or may not include arrow-like rotors that point towards the direction from which the wind is blowing.

The sensors 300 and 304 may also include a communication mechanism (not shown) through which it may send data that it collects to an outside system for evaluation. This communication mechanism may be a wired or wireless communication link. In some embodiments, the sensors 300 and 304 may communicate through the Internet. In other embodiments, the sensors 300 and 304 may communicate through a local communication link, such as a wired or local wireless link, such as a Bluetooth link.

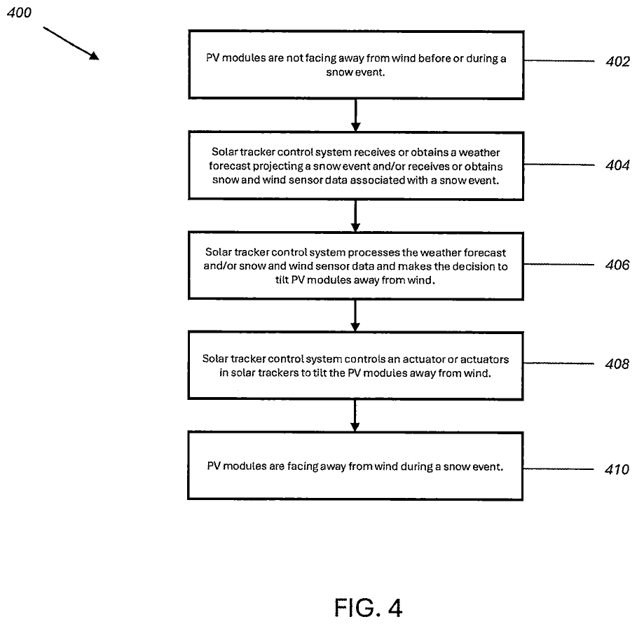

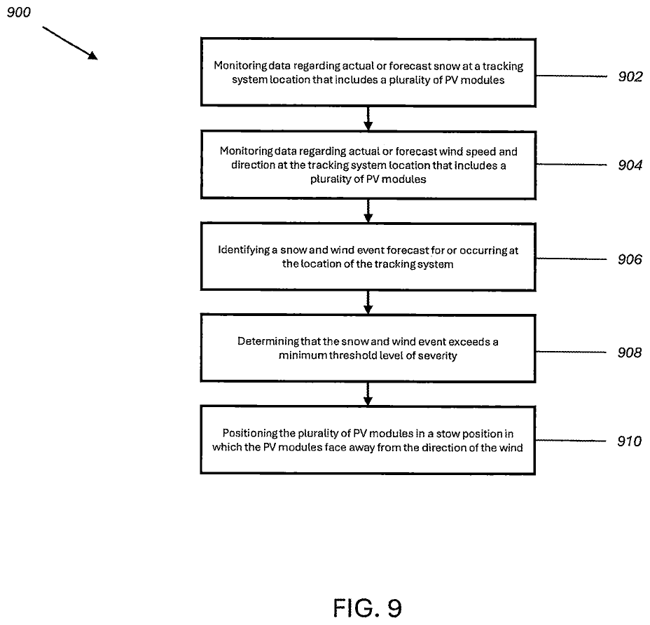

FIGS. 4-9 illustrates flow diagrams of example methods 400, 500, 600, 700, 800, and 900 for stowing one or more PV modules in response to a snow and wind event. These methods may be performed, in some embodiments, by a device or system, such as by the stow application 108 of FIG. 1. In these and other embodiments, these methods may be performed by one or more processors based on one or more computer-readable instructions stored on one or more non-transitory computer-readable media.

In some embodiments, a solar tracker control system may receive or obtain snow and wind information before or during a snow event. The solar tracker control system may then decide to tilt the PV modules to have them face away from the wind before or during a snow event, with the objective of reducing the amount of snow accumulation on PV modules during the snow event and thereby reducing the impact of snowfall on the PV power system's energy production after the snow event. The solar tracker control system may then control an actuator or actuators in the solar tracker control system to put PV modules at a tilt angle where the PV modules are facing away from the wind. Steps 402-410 of FIG. 4 illustrate these embodiments.

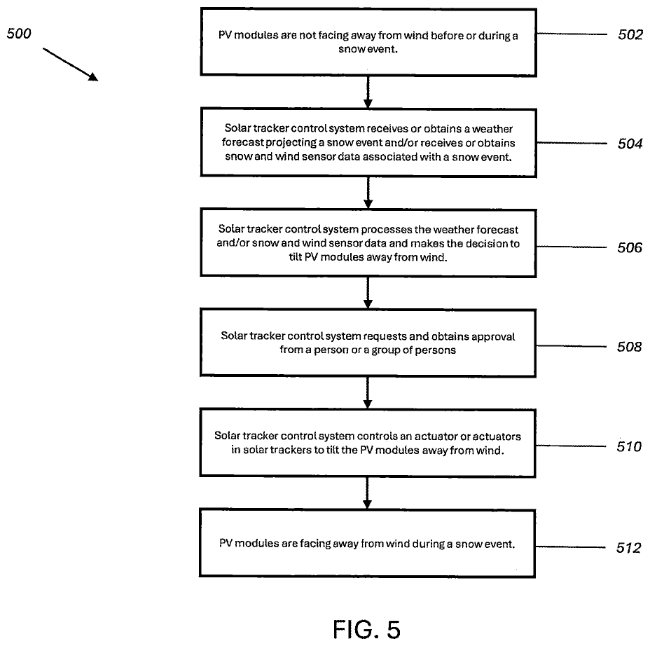

In some embodiments, a solar tracker control system may request approval from a person or a group of persons to approve of the solar tracker control system's decision to tilt the PV modules to have them face away from the wind before or during a snow event. The person or the group of persons may approve the decision with the intention of reducing the amount of snow accumulation on PV modules during the snow event and thereby reducing the impact of snowfall on the PV power system's energy production after the snow event. Steps 502-512 of FIG. 5 illustrate these embodiments.

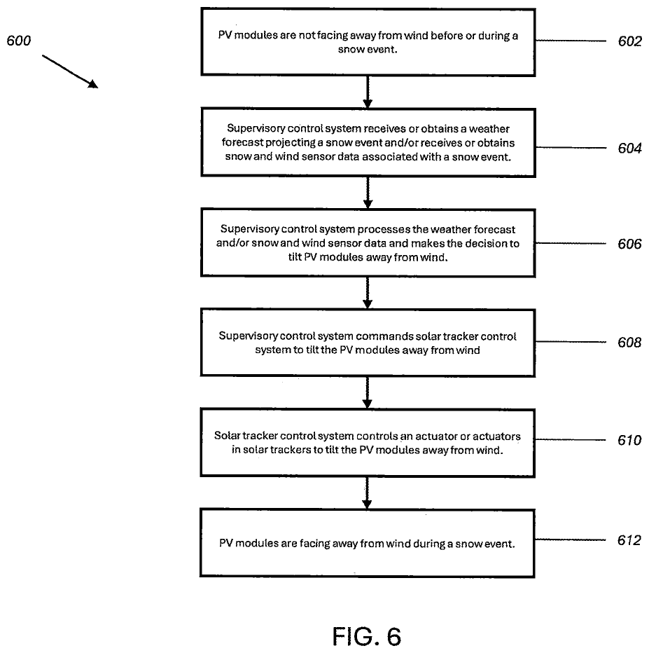

In some embodiments, a supervisory control system that supervises a solar tracker control system may receive or obtain snow and wind information before or during a snow event. The supervisory control system may then automatically tilt the PV modules to have them face away from the wind before or during a snow event, with the objective of reducing the amount of snow accumulation on PV modules during the snow event and thereby reducing the impact of snowfall on the PV power system's energy production after the snow event. The supervisory control system may then communicate with the solar tracker control system, so that the solar tracker control system controls an actuator or actuators in the solar tracker control system to put PV modules at a tilt angle where the PV modules are facing away from the wind. Steps 602-612 of FIG. 6 illustrate these embodiments.

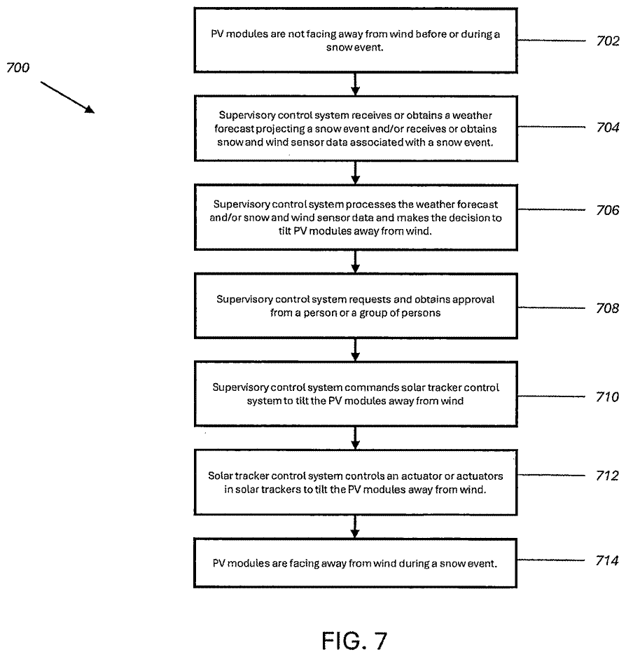

In some embodiments, a supervisory control system that supervises a solar tracker control may request approval from a person or a group of persons to approve of the supervisory control system's decision to tilt the PV modules to have them face away from the wind before or during a snow event. The person or the group of persons may approve the decision with the intention of reducing the amount of snow accumulation on PV modules during the snow event and thereby reducing the impact of snowfall on the PV power system's energy production after the snow event. Steps 702-714 of FIG. 7 illustrate these embodiments.

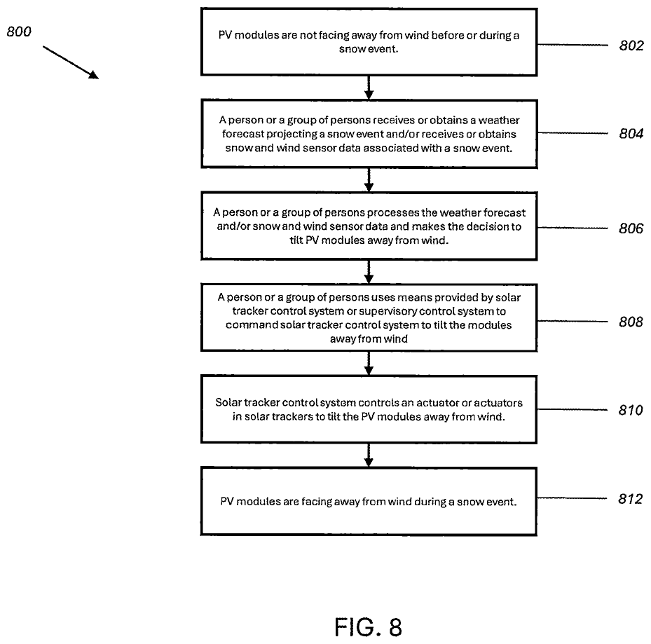

In some embodiments, a human supervisor or a group of human supervisors may receive or obtain snow and wind information before or during a snow event. The human supervisor or the group of human supervisors may then use the means provided by the solar tracker control system or its supervisory control system to command the solar tracker control system to tilt the PV modules away from the wind before or during a snow event, with the intention of reducing the amount of snow accumulation on PV modules during the snow event and thereby reducing the impact of snowfall on the PV power system's energy production after the snow event. Steps 802-812 of FIG. 8 illustrate these embodiments.

The method 900 may include, at action 902, monitoring weather data regarding actual or forecast snow at a tracking system location that includes a plurality of PV modules. The method 900 may include, at action 904, monitoring weather data regarding actual or forecast wind at a tracking system location that includes a plurality of PV modules. This data may be monitored through the weather forecast server 104 and/or the sensor 110 in FIG. 1.

The method 900 may include, at action 906, identifying a snow and wind event forecast for or occurring at the location of the tracking system. The method 900 may include, at action 908, determining that the snow and wind event exceeds a minimum threshold level of severity. The method 900 may include, at action 910, positioning the plurality of PV modules in a stow position in which the PV modules face away from the direction of the wind

FIG. 10 illustrates an example computer system 1000 that may be employed in stowing one or more PV modules in response to a weather event forecast. In some embodiments, the computer system 1000 may be part of any of the systems or devices described in this disclosure. For example, the computer system 1000 may be part of any of the weather forecasting server 104 and the control server 106 of FIG. 1.

The computer system 1000 may include a processor 1002, a memory 1004, a file system 1006, a communication unit 1008, an operating system 1010, a user interface 1012, and an application 1014, which all may be communicatively coupled. In some embodiments, the computer system may be, for example, a desktop computer, a client computer, a server computer, a mobile phone, a laptop computer, a smartphone, a smartwatch, a tablet computer, a portable music player, a networking device, or any other computer system.

Generally, the processor 1002 may include any suitable special-purpose or general-purpose computer, computing entity, or processing device including various computer hardware or software applications and may be configured to execute instructions stored on any applicable computer-readable storage media. For example, the processor 1002 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 1002 may interpret and/or execute program instructions and/or process data stored in the memory 1004 and/or the file system 1006. In some embodiments, the processor 1002 may fetch program instructions from the file system 1006 and load the program instructions into the memory 1004. After the program instructions are loaded into the memory 1004, the processor 1002 may execute the program instructions. In some embodiments, the instructions may include the processor 1002 performing one or more of the actions of the methods disclosed herein.

The memory 1004 and the file system 1006 may include computer-readable storage media for carrying or having stored thereon computer-executable instructions or data structures. Such computer-readable storage media may be any available non-transitory media that may be accessed by a general-purpose or special-purpose computer, such as the processor 1002. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1002 to perform a certain operation or group of operations, such as one or more of the actions of the methods disclosed herein. These computer-executable instructions may be included, for example, in the operating system 1010, in one or more applications, such as the stow application 108 of FIG. 1.

The communication unit 1008 may include any component, device, system, or combination thereof configured to transmit or receive information over a network, such as the network 102 of FIG. 1. In some embodiments, the communication unit 1008 may communicate with other devices at other locations, the same location, or even other components within the same system. For example, the communication unit 1008 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 1008 may permit data to be exchanged with a network and/or any other devices or systems, such as those described in the present disclosure.

The operating system 1010 may be configured to manage hardware and software resources of the computer system 1000 and configured to provide common services for the computer system 1000.

The user interface 1012 may include any device configured to allow a user to interface with the computer system 1000. For example, the user interface 1012 may include a display, such as an LCD, LED, or other display, that is configured to present video, text, application user interfaces, and other data as directed by the processor 1002. The user interface 1012 may further include a mouse, a track pad, a keyboard, a touchscreen, volume controls, other buttons, a speaker, a microphone, a camera, any peripheral device, or other input or output device. The user interface 1012 may receive input from a user and provide the input to the processor 1002. Similarly, the user interface 1012 may present output to a user.

The application 1014 may be one or more computer-readable instructions stored on one or more non-transitory computer-readable media, such as the memory 1004 or the file system 1006, that, when executed by the processor 1002, is configured to perform one or more of the actions of the methods disclosed herein. In some embodiments, the application 1014 may be part of the operating system 1010 or may be part of an application of the computer system 1000, or may be some combination thereof. In some embodiments, the application 1014 may function as the stow application 108 of FIG. 1.

Modifications, additions, or omissions may be made to the computer system 1000 without departing from the scope of the present disclosure. For example, although each is illustrated as a single component in FIG. 10, any of the components 1002-1014 of the computer system 1000 may include multiple similar components that function collectively and are communicatively coupled. Further, although illustrated as a single computer system, it is understood that the computer system 1000 may include multiple physical or virtual computer systems that are networked together, such as in a cloud computing environment, a multitenancy environment, or a virtualization environment.

As indicated above, the embodiments described herein may include the use of a special purpose or general purpose computer (e.g., the processor 1002 of FIG. 10) including various computer hardware or software applications, as discussed in greater detail below. Further, as indicated above, embodiments described herein may be implemented using computer-readable media (e.g., the memory 1004 or file system 1006 of FIG. 10) for carrying or having computer-executable instructions or data structures stored thereon.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure

What is claimed is:

1. A method for stowing photovoltaic (PV) modules in a solar tracking installation, the method comprising:
receiving weather information, the weather information including a wind speed and a wind direction before or during a snow event; and
stowing the PV modules so that the PV modules are facing away from the wind direction before or during the snow event.

2. The method of claim 1, wherein the wind speed and the wind direction are obtained from a weather forecast for a location where the PV modules are installed.

3. The method of claim 1, wherein the wind speed and wind direction are obtained from a sensor installed in a location where the PV modules are installed.

4. The method of claim 1, wherein the wind speed and the wind direction are obtained from a weather forecast for a location where the PV modules are installed and from a sensor installed in the location where the PV modules are installed.

5. The method of claim 1, wherein the weather information includes a forecasted time of the snow event.

6. The method of claim 5, wherein the stowing of PV modules happens prior to the forecasted time of the snow event.

7. The method of claim 1, wherein the stowing of PV modules is achieved by controlling a tilt angle of a solar tracker with an actuator that is part of a solar tracker.

8. A method for stowing photovoltaic (PV) modules, the method comprising:
receiving, from a weather forecasting service, a weather forecast for a solar tracking installation location that includes a plurality of PV modules, wherein the weather forecast identifies a snow event to occur at the solar tracking installation location;
receiving weather information from a sensor installed at the solar tracking installation location, the weather information including a wind speed and a wind direction at the solar tracking installation location; and
positioning the plurality of PV modules in a stow position in which the PV modules face away from the wind direction prior to an expected arrival of the snow event at the solar tracking installation location.

9. The method of claim 8, wherein the weather forecast includes a level of severity of the snow event.

10. The method of claim 9, further comprising determining that the level of severity of the snow event exceeds a threshold level of severity.

11. A system for stowing photovoltaic (PV) modules, the system comprising:
a plurality of PV modules secured to a torque tube at s solar tracking installation location;
a motor attached to the torque tube and configured to change an angular orientation of the plurality of PV modules;
a sensor installed at the solar tracking installation location;
one or more processors; and
one or more non-transitory computer-readable media comprising one or more computer-readable instructions that, when executed by the one or more processors, cause the computing device to perform a method for stowing the plurality of PV modules, the method comprising:
receiving, from a weather forecasting service, a weather forecast for the solar tracking installation location, wherein the weather forecast identifies a snow event to occur at the solar tracking installation location;
receiving weather information from the sensor installed at the solar tracking installation location, the weather information including a wind speed and a wind direction at the solar tracking installation location; and
positioning the plurality of PV modules in a stow position in which the PV modules face away from the wind direction prior to an expected arrival of the snow event at the solar tracking installation location.

12. The system of claim 11, wherein the weather forecast includes a level of severity of the snow event.

13. The system of claim 12, wherein the method performed by the computing device further comprises determining that the level of severity of the snow event exceeds a threshold level of severity.
